(19) United States
(12) Patent Application Publication
(10) Pub. No.: US 2026/0015895 A1
(43) Pub. Date: Jan. 15, 2026

(54) VEHICLE LATCH RELEASE ASSEMBLIES

(71) Applicant: FORD GLOBAL TECHNOLOGIES, LLC, Dearborn, MI (US)

(72) Inventors: Collin Meister, Canton, MI (US); Constantin Manolescu, Dearborn, MI (US)

(21) Appl. No.: 18/767,233

(22) Filed: Jul. 9, 2024

(51) Int. Cl. E05B 83/26; E05B 79/20; E05B 81/08; E05B 81/90

(52) U.S. Cl. CPC E05B 83/26; E05B 79/20; E05B 81/08; E05B 81/90

(57) ABSTRACT

A device may include a closure member moveable between a closed position and an open position. A device may include a latch configured for holding the closure member in the closed position. A device may include a latch release assembly configured to release the latch to allow the closure member to be moved to the open position, wherein the latch release assembly includes an actuator moveable from a deployed position to a retracted position when the vehicle is in a powered-off state, and a coupler moveable between a locked position and an unlocked position when the actuator is in the retracted position.

### TECHNICAL FIELD

This disclosure relates generally to vehicle closure member systems, and more particularly to latch release assemblies for vehicle closure member systems.

### BACKGROUND

Vehicle closure members typically utilize a striker and a latch to hold the closure member in a closed position. The striker engages the latch to lock it in place and thereby hold the closure member in the closed position.

### SUMMARY

In some aspects, the techniques described herein relate to a closure member system for a vehicle, including: a closure member moveable between a closed position and an open position; a latch configured for holding the closure member in the closed position; and a latch release assembly configured to release the latch to allow the closure member to be moved to the open position, wherein the latch release assembly includes an actuator moveable from a deployed position to a retracted position when the vehicle is in a powered-off state, and a coupler moveable between a locked position and an unlocked position when the actuator is in the retracted position.

In some aspects, the techniques described herein relate to a closure member system, further including a first actuation cable and a second actuation cable each coupled to opposite ends of the coupler.

In some aspects, the techniques described herein relate to a closure member system, wherein the first actuation cable includes a first end and an opposite second end, the first end coupled to the coupler and the second end coupled to an emergency release system.

In some aspects, the techniques described herein relate to a closure member system, wherein the emergency release system is arranged in a compartment of the vehicle and configured to move the first actuation cable in a first direction to pivot the coupler about a coupler axis to the unlocked position.

In some aspects, the techniques described herein relate to a closure member system, wherein the compartment is a frunk and the closure member is a hood.

In some aspects, the techniques described herein relate to a closure member system, wherein the second actuation cable includes a first end and an opposite second end, the first end coupled to the coupler and the second end coupled to the latch.

In some aspects, the techniques described herein relate to a closure member system, wherein when the coupler is moved to the unlocked position, the second actuation cable is moved in a first direction to release the latch to allow the closure member to move to the open position.

In some aspects, the techniques described herein relate to a closure member system, wherein the actuator includes a plunger that holds the coupler in the locked position when the actuator is in the deployed position.

In some aspects, the techniques described herein relate to a closure member system, wherein the coupler includes a body and a stop that projects laterally from the body and engages the actuator when the actuator is in the deployed position.

In some aspects, the techniques described herein relate to a closure member system, further including a biasing member that biases the coupler to the locked position.

In some aspects, the techniques described herein relate to a closure member system, wherein when the actuator is in the retracted position and the coupler is in the unlocked position, the latch is released to allow the closure member to move to the open position.

In some aspects, the techniques described herein relate to a closure member system, wherein the actuator is a solenoid.

In some aspects, the techniques described herein relate to a closure member system, wherein the actuator is a magnetic pawl.

In some aspects, the techniques described herein relate to a method, including: automatically moving an actuator of a latch release assembly of a vehicle from a deployed position to a retracted position in response to the vehicle experiencing a powered-off state, wherein a coupler of the latch release assembly is manually movable to an unlocked position to release a latch of a closure member of the vehicle when the actuator is in the retracted position.

In some aspects, the techniques described herein relate to a method, wherein the coupler pivots about a coupler axis to the unlocked position in response to a first actuation cable moving in a first direction.

In some aspects, the techniques described herein relate to a method, wherein the first actuation cable is moved in the first direction in response to activating a release mechanism arranged in a compartment of the vehicle.

In some aspects, the techniques described herein relate to a method, wherein the compartment is a frunk.

In some aspects, the techniques described herein relate to a method, further including biasing the coupler to cause the coupler to pivot from the unlocked position to a locked position in response to deactivating the release mechanism.

In some aspects, the techniques described herein relate to a method, wherein the latch is released in response to a second actuation cable moving in a first direction.

In some aspects, the techniques described herein relate to a method, wherein the second actuation cable is moved in the first direction when the coupler is moved to the unlocked position.

The embodiments, examples, and alternatives of the preceding paragraphs, the claims, or the following description and drawings, including any of their various aspects or respective individual features, may be taken independently or in any combination. Features described in connection with one embodiment are applicable to all embodiments, unless such features are incompatible.

The various features and advantages of this disclosure will become apparent to those skilled in the art from the following detailed description. The drawings that accompany the detailed description can be briefly described as follows.

### BRIEF DESCRIPTION OF THE DRAWINGS

FIG. 1 schematically illustrates a vehicle.

FIG. 2 illustrates a closure member system of the vehicle of FIG. 1.

FIG. 3 is a perspective view of select portions of the closure member system of FIG. 2.

FIG. 4 illustrates an exemplary latch release assembly including an actuator in a deployed position and a coupler in a locked position.

FIG. 5 illustrates the actuator of FIG. 4 in a retracted position and the coupler of FIG. 4 in an unlocked position.

FIG. 6 illustrates another exemplary latch release assembly including an actuator in a deployed position and a coupler in a locked position.

FIG. 7 illustrates the actuator of FIG. 6 in a retracted position and the coupler of FIG. 6 in an unlocked position.

### DETAILED DESCRIPTION

This disclosure details closure member systems for vehicles. An exemplary closure member system may include a closure member that is movable between a closed position and an open position. The exemplary closure member system includes a latch release assembly. The latch release assembly is configured to release a latch to allow the closure member to be moved to the open position when the vehicle is powered off or has lost power. These and other features are discussed in greater detail in the following paragraphs of this detailed description.

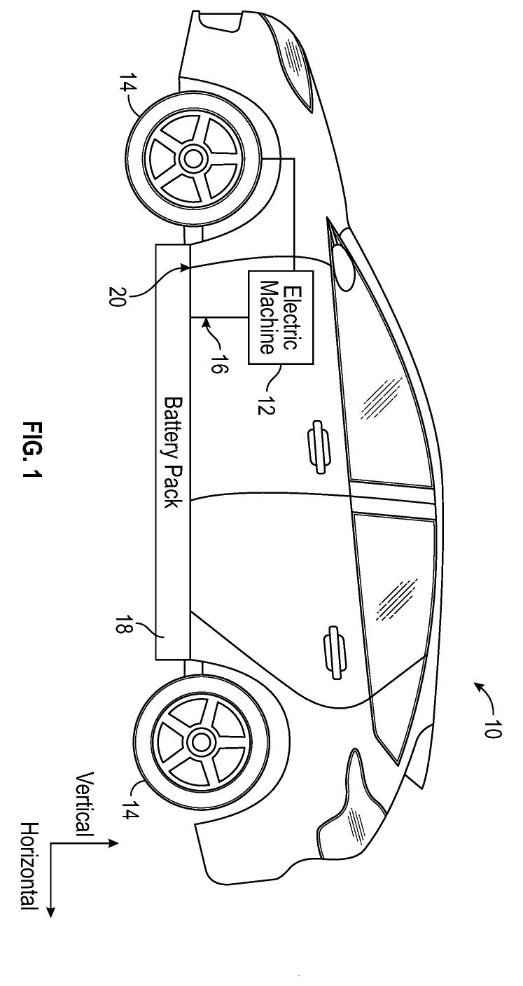

FIG. 1 schematically illustrates an example vehicle 10. The vehicle 10 may include any type of powertrain. In an embodiment, the vehicle 10 is a battery electric vehicle (BEV). However, the concepts described herein are not limited to BEVs and could extend to other electrified vehicles, including, but not limited to, hybrid electric vehicles (HEVs), plug-in hybrid electric vehicles (PHEV’s), fuel cell vehicles, etc. In still other embodiments, the vehicle 10 is a conventional internal combustion engine driven vehicle. Therefore, although not specifically shown in the exemplary embodiment, the powertrain of the vehicle 10 could be equipped with an internal combustion engine that can be employed either alone or in combination with other power sources to propel the vehicle 10.

In the illustrated embodiment, the vehicle 10 is depicted as a car. However, the vehicle 10 could alternatively be a sport utility vehicle (SUV), a van, a pickup truck, or any other vehicle configuration. Although a specific component relationship is illustrated in the figures of this disclosure, the illustrations are not intended to limit this disclosure. The placement and orientation of the various components of the vehicle 10 are shown schematically and could vary within the scope of this disclosure. In addition, the various figures accompanying this disclosure are not necessarily drawn to scale, and some features may be exaggerated or minimized to emphasize certain details of a particular component or system.

In an embodiment, the vehicle 10 is a full electric vehicle propelled solely through electric power, such as by one or more electric machines 12, without any assistance from an internal combustion engine. The electric machine 12 may operate as an electric motor, an electric generator, or both. The electric machine 12 receives electrical power and can convert the electrical power to torque for driving one or more wheels 14 of the vehicle 10.

A voltage bus 16 may electrically couple the electric machine 12 to a traction battery pack 18. The traction battery pack 18 is an exemplary electrified vehicle battery. The traction battery pack 18 may be a high voltage traction battery pack assembly that includes a plurality of battery cell groupings capable of outputting electrical power to power the electric machine 12 and/or other electrical loads of the vehicle 10. Other types of energy storage devices and/or output devices could alternatively or additionally be used to electrically power the vehicle 10.

The traction battery pack 18 may be secured to an underbody 20 of the vehicle 10. However, the traction battery pack 18 could be located elsewhere on the vehicle 10 within the scope of this disclosure.

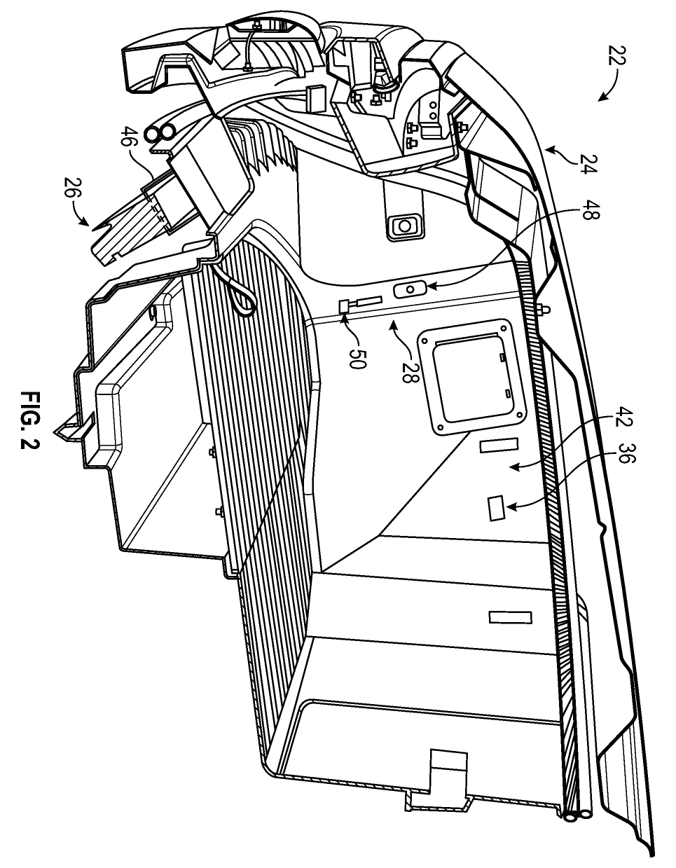

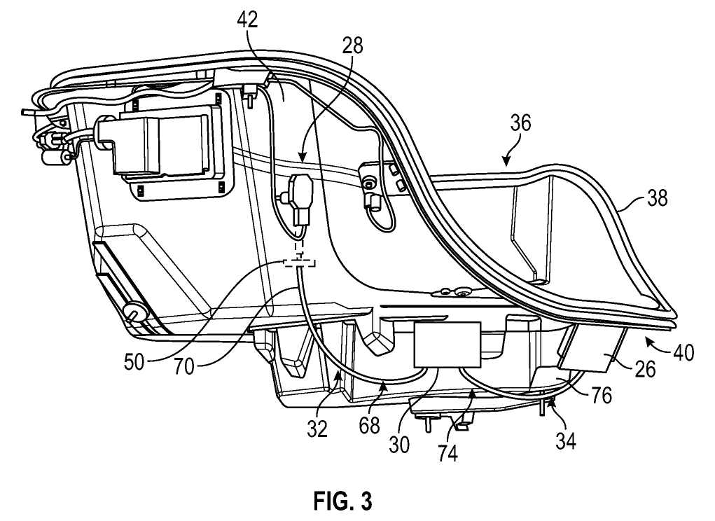

With reference to FIGS. 2 and 3, the vehicle 10 may include a closure member system 22. The closure member system 22 may include a closure member 24, a latch 26, an emergency release system 28, a latch release assembly 30, a first actuation cable 32 that may be operably coupled to the emergency release system 28 and the latch release assembly 30, and a second actuation cable 34 that may be operably coupled to the latch 26 and the latch release assembly 30. Although the closure member 24 is described herein as a hood or decklid, it should be understood that the closure member 24 could be a door, tailgate, trunk lid, or any other type of closure member configuration.

The closure member 24 may be moved between a closed position and an open position. When in the closed position, the closure member 24 may provide a barrier between the interior and exterior of the vehicle 10. When in the open position, the closure member 24 may permit users to access a compartment, here a frunk 36 of the vehicle 10, for example.

The compartment 36 may be provided by a storage bin 38 that supports the latch 26, the emergency release system 28, and the latch release assembly 30. The latch 26 may be secured to an underbody 40 of the storage bin 38. In an embodiment, the latch 26 may be secured to the front bolster of the vehicle 10. The emergency release system 28 may be secured to a side wall 42 of the storage bin 38 such that the emergency release system 28 may be accessible from inside the compartment 36. The first and second actuation cables 32, 34 (indicated in dashed lines in FIG. 3 for illustrative purposes) may be routed through or otherwise along the storage bin 38.

The latch 26 may be configured to engage a striker 46 of the closure member 24. The striker 46 may be secured to the underside of the closure member 24. When in the closed position, the latch 26 may engage the striker 46 to hold the closure member 24 in the closed position. The closure member 24 may be moved to the open position when the latch 26 has been disengaged from the striker 46.

The emergency release system 28 may include a button 48 and a handle 50 that may be arranged in the compartment 36 and is configured to allow someone inside the compartment 36 to actuate the latch 26 to allow the closure member 24 to be moved from the closed position to the open position. In an embodiment, the handle 50 may be integrated with the button 48. The button 48 may be powered by the traction battery pack 18 of the vehicle 10 (see FIG. 1) or an auxiliary power source that supplies electricity to electrical systems of the vehicle 10. When the vehicle 10 is in a powered-on state (i.e., power is supplied to the electrical systems of the vehicle 10), the button 48 may function as an electrical switch that, when pressed, signals the latch 26 to release or otherwise disengage the striker 46 to allow the closure member 24 to be moved to the open position. The handle 50 may be mechanically coupled to the latch release assembly 30 by the first actuation cable 32 and is configured to release the latch 26 to allow the closure member 24 to move to the open position when the vehicle 10 is in a powered-off state. As used herein, “powered-off state” means the vehicle 10 has experienced a loss of power, has been placed in an ignition-off state, or has been placed in a low-power state.

In the illustrated embodiment, the latch release assembly 30 may be a separate module from the latch 26. In another embodiment, the latch release assembly 30 may be integrated with the latch 26 within a single module.

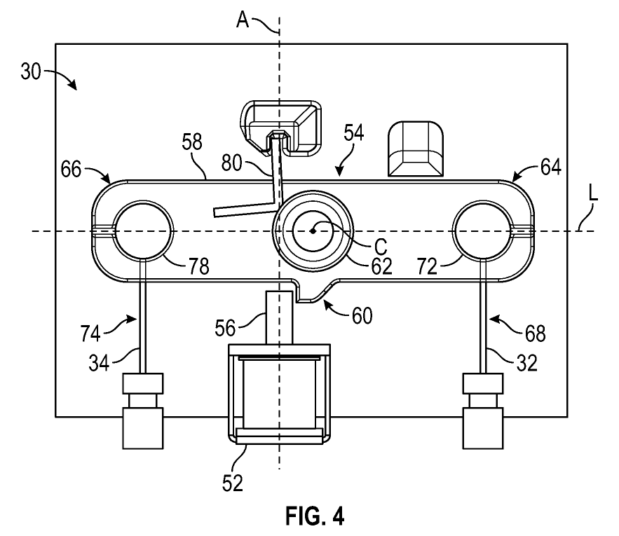

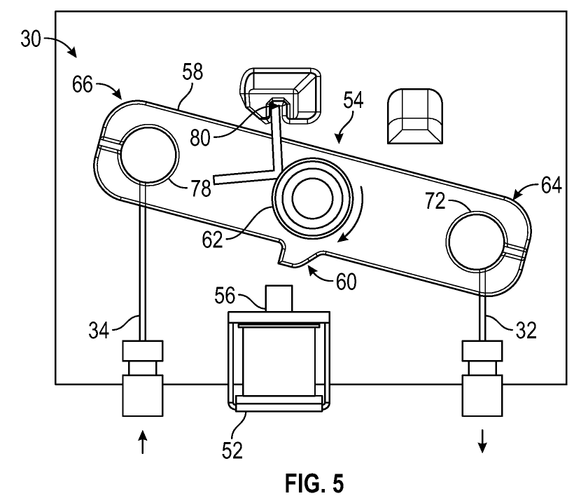

FIGS. 4-5 illustrate additional details associated with the latch release assembly 30 of the closure member system 22 described above. The latch release assembly 30 may include an actuator 52 and a coupler 54. The actuator 52 may be configured to automatically move from a deployed position (FIG. 4) to a retracted position (FIG. 5) when the vehicle 10 is in a powered-off state. In the illustrated embodiment, the actuator 52 may be a solenoid that is powered by the traction battery pack 18 of the vehicle 10 or an auxiliary power source that supplies electricity to electrical systems of the vehicle 10. The actuator 52 may include a plunger 56 that is linearly movable along an actuator axis A in response to the vehicle 10 being powered on and off. When the vehicle 10 is powered on, the plunger 56 automatically moves along the actuator axis A to move the actuator 52 to the deployed position. When the vehicle 10 is powered off or has lost power, the plunger 56 automatically moves along the actuator axis A to move the actuator 52 to the retracted position.

In an embodiment, the actuator 52 may include an internal magnetic coil and an internal return spring for automatically moving the plunger 56 between the deployed position and the retracted position. The plunger 56 may be made of a magnetic material. When the vehicle 10 is powered on, electric current is passed through the internal magnetic coil, which creates a magnetic field between the internal spring and the plunger 56 sufficient to magnetize the plunger 56 and pull or otherwise move the plunger 56 along the actuator axis A to the deployed position. The plunger 56 moves against the force of the internal return spring. When the vehicle 10 is powered off or loses power, the magnetic field between the internal magnetic coil and the plunger 56 is lost, and the internal spring pushes or otherwise moves the plunger 56 along the actuator axis A to the retracted position.

The coupler 54 may be moveable from a locked position (FIG. 4) to an unlocked position (FIG. 5) when the actuator 52 is in the retracted position. In the illustrated embodiment, the coupler 54 may pivot about a coupler axis C from the locked position to the unlocked position. The coupler 54 may include a body 58 and a stop 60. The body 58 may be pivotably coupled to the storage bin 38 of the compartment 36 via a coupler pin 62 that provides the coupler axis C around which the coupler 54 pivots. The body 58 may extend along a longitudinal axis L between a first end 64 and an opposite second end 66. As discussed further below, the first end 64 may be operably coupled to the first actuation cable 32, and the second end 66 may be operably coupled to the second actuation cable 34. The stop 60 may project laterally (e.g., generally perpendicularly or transversely) from the body 58. The stop 60 may contact or otherwise engage the plunger 56 of the actuator 52 when the actuator 52 is in the deployed position to block the coupler 54 from moving to the unlocked position.

The first actuation cable 32 may provide a connection between the coupler 54 and the emergency release system 28. The first actuation cable 32 may include a first end 68 and an opposite second end 70. The first end 68 may be coupled to the coupler 54. In the illustrated embodiment, the first end 68 may include a pin 72 that may be supported within a hole formed in the body 58 of the coupler 54. The second end 70 may be coupled to the handle 50 of the emergency release system 28 (see FIG. 3).

The second actuation cable 34 may provide a connection between the coupler 54 and the latch 26. The second actuation cable 34 may include a first end 74 and a second end 76. The first end 74 may be coupled to the coupler 54. In the illustrated embodiment, the first end 74 may include a pin 78 that may be supported within a hole formed in the body 58 of the coupler 54. The second end 76 may be coupled to the latch 26 (see FIG. 3).

In the illustrated embodiment, the first actuation cable 32 and the second actuation cable 34 may extend laterally (e.g., generally perpendicularly or transversely) from opposite ends of the body 58 of the coupler 54 to pivot the coupler 54 about the coupler axis C when pulled. In another embodiment, the coupler 54 may be coupled to the storage bin 38 by a sliding rivet, and first actuation cable 32 and the second actuation cable 34 may extend longitudinally from opposite ends of the body 58 to slide the coupler 54 along the longitudinal axis L when pulled.

The latch release assembly 30 may be configured to release the latch 26 from the striker 46 to allow the closure member 24 to be moved from the closed position to the open position when the vehicle 10 is in the powered-off state. For example, when the vehicle 10 is powered off, the plunger 56 of the actuator 52 may automatically move from the deployed position (FIG. 4) to the retracted position (FIG. 5). The handle 50 of the emergency release system 28 may be pulled (e.g., engaged) from within the compartment 36 to pull or otherwise move the first actuation cable 32 in a first direction toward the emergency release system 28, which causes the coupler 54 to pivot about the coupler axis C from the locked position (FIG. 4) to the unlocked position (FIG. 5). As the coupler 54 pivots to the unlocked position, the coupler 54 may pull or otherwise move the second actuation cable 34 in a first direction away from the latch 26 to release or otherwise disengage the latch 26 from the striker 46 of the closure member 24 to allow the closure 24 to be moved to the open position. When the handle 50 is released (e.g., disengaged), a biasing member (e.g., torsion spring) 80 may apply a biasing force on the coupler 54 to bias the coupler 54 to the locked position. When the vehicle is powered on, the plunger 56 may automatically move to the deployed position to engage the stop 60 of the coupler 54 to block the coupler 54 from pivoting to the unlocked position.

In this disclosure, like reference numerals designate like elements where appropriate and reference numerals with the addition of one-hundred or multiples thereof designate modified elements that are understood to incorporate the same features and benefits of the corresponding elements.

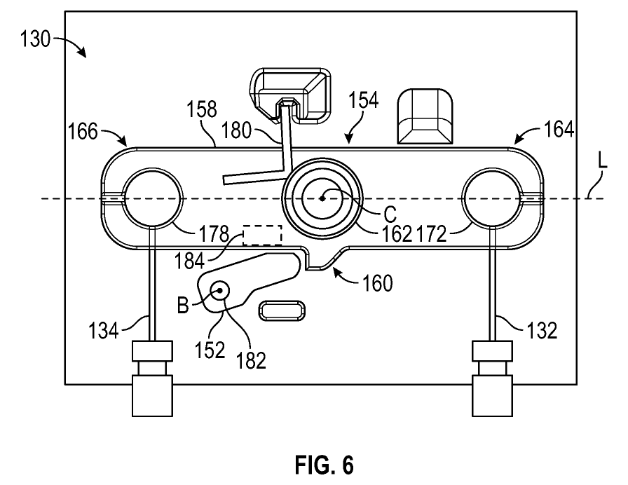

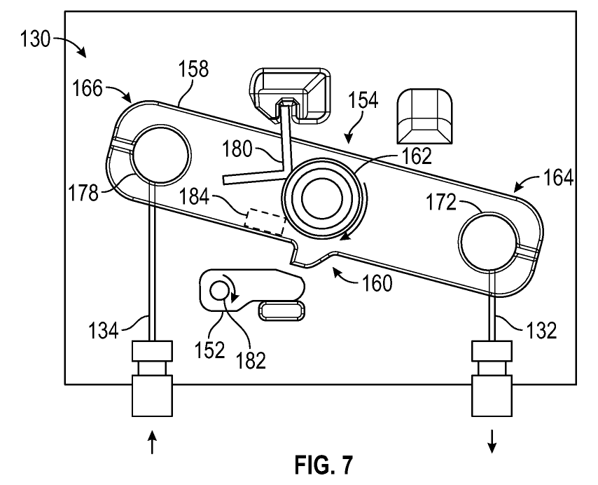

FIGS. 6 and 7 illustrate a latch release assembly 130 according to another embodiment. The latch release assembly 130 may include an actuator 152 and a coupler 154. The actuator 152 may be configured to pivot or otherwise move about an actuator axis B from a deployed position (FIG. 6) to a retracted position (FIG. 7) in response to the vehicle 10 of FIG. 1 being powered off. In this embodiment, the actuator 152 may be an electromagnetic pawl that is powered by the traction battery pack 18 of the vehicle 10 or an auxiliary power source that supplies electricity to electrical systems of the vehicle 10. The actuator 152 may be pivotably coupled to the storage bin 38 of the compartment 36 via an actuator pin 182 that provides the actuator axis B around which the actuator 152 pivots. An electromagnet 184 may be embedded in the coupler 154. In an embodiment, the electromagnet 184 may be a ferrous rod wrapped in wire. When the vehicle 10 is powered on, electrical power is supplied to the electromagnet 184, which creates a magnetic field between the actuator 152 and the electromagnet 184. The magnetic field may be sufficient to automatically pivot the actuator 152 to the deployed position and hold the actuator 152 in engagement with a stop 160 of the coupler 154 to block the coupler 154 from pivoting from a locked position (FIG. 6) to an unlocked position (FIG. 7). When the vehicle 10 is powered off, the magnetic field between the actuator 152 and the electromagnet 184 is lost, and gravity causes the actuator 152 to automatically pivot to the retracted position to allow the closure member 24 to move to the open position.

The exemplary closure member system of this disclosure is operable to allow a closure member of a vehicle to move from a closed position to an open position when the vehicle is powered off or has lost power. The exemplary latch release assembly is configured to release a latch to allow the closure member to move to the open position when the vehicle is powered off. The proposed closure member system designs can be used as manual systems operable without electrical power for opening a closure member of a vehicle from within a vehicle compartment.

Although the different non-limiting embodiments are illustrated as having specific components or steps, the embodiments of this disclosure are not limited to those particular combinations. It is possible to use some of the components or features from any of the non-limiting embodiments in combination with features or components from any of the other non-limiting embodiments.

It should be understood that like reference numerals identify corresponding or similar elements throughout the several drawings. It should be understood that although a particular component arrangement is disclosed and illustrated in these exemplary embodiments, other arrangements could also benefit from the teachings of this disclosure.

The foregoing description shall be interpreted as illustrative and not in any limiting sense. A worker of ordinary skill in the art would understand that certain modifications could come within the scope of this disclosure. For these reasons, the following claims should be studied to determine the true scope and content of this disclosure.

What is claimed is:

1. A closure member system for a vehicle, comprising:
a closure member moveable between a closed position and an open position;
a latch configured for holding the closure member in the closed position; and
a latch release assembly configured to release the latch to allow the closure member to be moved to the open position,
wherein the latch release assembly includes an actuator moveable from a deployed position to a retracted position when the vehicle is in a powered-off state, and a coupler moveable between a locked position and an unlocked position when the actuator is in the retracted position.

2. The closure member system as recited in claim 1, further comprising a first actuation cable and a second actuation cable each coupled to opposite ends of the coupler.

3. The closure member system as recited in claim 2, wherein the first actuation cable includes a first end and an opposite second end, the first end coupled to the coupler and the second end coupled to an emergency release system.

4. The closure member system as recited in claim 3, wherein the emergency release system is arranged in a compartment of the vehicle and configured to move the first actuation cable in a first direction to pivot the coupler about a coupler axis to the unlocked position.

5. The closure member system as recited in claim 4, wherein the compartment is a frunk and the closure member is a hood.

6. The closure member system as recited in claim 2, wherein the second actuation cable includes a first end and an opposite second end, the first end coupled to the coupler and the second end coupled to the latch.

7. The closure member system as recited in claim 6, wherein when the coupler is moved to the unlocked position, the second actuation cable is moved in a first direction to release the latch to allow the closure member to move to the open position.

8. The closure member system as recited in claim 1, wherein the actuator includes a plunger that holds the coupler in the locked position when the actuator is in the deployed position.

9. The closure member system as recited in claim 1, wherein the coupler includes a body and a stop that projects laterally from the body and engages the actuator when the actuator is in the deployed position.

10. The closure member system as recited in claim 1, further comprising a biasing member that biases the coupler to the locked position.

11. The closure member system as recited in claim 1, wherein when the actuator is in the retracted position and the coupler is in the unlocked position, the latch is released to allow the closure member to move to the open position.

12. The closure member system as recited in claim 1, wherein the actuator is a solenoid.

13. The closure member system as recited in claim 1, wherein the actuator is a magnetic pawl.

14. A method, comprising:
automatically moving an actuator of a latch release assembly of a vehicle from a deployed position to a retracted position in response to the vehicle experiencing a powered-off state,
wherein a coupler of the latch release assembly is manually movable to an unlocked position to release a latch of a closure member of the vehicle when the actuator is in the retracted position.

15. The method as recited in claim 14, wherein the coupler pivots about a coupler axis to the unlocked position in response to a first actuation cable moving in a first direction.

16. The method as recited in claim 15, wherein the first actuation cable is moved in the first direction in response to activating a release mechanism arranged in a compartment of the vehicle.

17. The method as recited in claim 16, wherein the compartment is a frunk.

18. The method as recited in claim 16, further comprising biasing the coupler to cause the coupler to pivot from the unlocked position to a locked position in response to deactivating the release mechanism.

19. The method as recited in claim 14, wherein the latch is released in response to a second actuation cable moving in a first direction.

20. The method as recited in claim 19, wherein the second actuation cable is moved in the first direction when the coupler is moved to the unlocked position.
